(19) United States
(12) Patent Application Publication
(10) Pub. No.: US 2022/0109781 A1
(43) Pub. Date: Apr. 7, 2022

(54) COLOR MATCHING

(71) Applicant: Hewlett-Packard Development Company, L.P., Spring, TX (US)

(72) Inventors: Jan Morovic, London (GB); Jordi Arnabat Benedicto, Sant Cugat del Valles (ES); Alessandro Beltrami, Sant Cugat del Valles (ES); Gregory Braverman, Ness Ziona (IL); Joseph Stellbrink, Corvallis, OR (US); Peter Morovic, Sant Cugat del Valles (ES); Dan Bavli, Netanya (IL)

(73) Assignee: Hewlett-Packard Development Company, L.P., Spring, TX (US)

(21) Appl. No.: 17/419,141

(22) PCT Filed: Jun. 13, 2019
(86) PCT No.: PCT/US2019/037020

§ 371 Date: Jun. 28, 2021

(51) Int. Cl. H04N 1/60

(52) U.S. Cl. CPC H04N 1/6055; H04N 1/6072; H04N 1/6033

(57) ABSTRACT

Certain examples relate to a method of color matching by confirming a color-rendering device. Color reproduction parameters are determined for a reference and target color-rendering device. A color matching parameter is determined for the target color-rendering device based on a comparison of the color reproduction parameter for the target color-rendering device with the corresponding color reproduction parameter of the reference color-rendering device. The color-rendering device is confirmed dependent on the color matching parameter. Color resources of the target color-rendering device are configured such that a rendering of a color image on the target color-rendering device replicates a rendering of the color image on the reference color-rendering device.

### BACKGROUND

Image rendering devices such as display monitors and printers may be used to render a color image onto a medium such as an LCD screen or paper. The color image may be received as digital image data, where the image data indicates color values in a color space for pixels of the image. For example, a Red, Green, Blue (RGB) image may have a first number of pixels in an x-direction and a second number of pixels in a y-direction, where each pixel has a value in a Red, Green Blue (RGB) color space. In these cases, each pixel may be represented as a triple or tristimulus value, e.g. if each value is represented using 8-bits, three variables in the range 0-255 such as (125, 76, 12). To render the color image, the image rendering device needs to represent the digital image data in a color space that is appropriate for its available color resources. For example a printer may include printing fluids of Cyan, Magenta, Yellow and Black and so represent colors within a CMYB color space. Based on the same image data, the color image rendered by one color-rendering device may contain colors which appear different compared with the color image rendered by a different color-rendering device.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of a color matching system according to an example;

FIG. 2 is a schematic of a graphical user interface according to an example;

FIG. 3 is a flow chart showing a method of color matching; and

FIG. 4 is a schematic diagram of a non-transitory computer-readable storage medium according to an example.

### DETAILED DESCRIPTION

Certain examples described herein address a challenge of color matching across different color-rendering devices. In an example, rendering an image on a target color-rendering device such that it substantially replicates or at least sufficiently approximates the same image rendered by a different reference color-rendering device may be achieved by selecting an appropriate target color-rendering device using an objective assessment based on properties of the reference and target color-rendering devices. In another example, the ability of a target color-rendering device to replicate an image rendered by or sufficiently reproduce the colors produced by a reference color-rendering device may be assessed using a guided color matching system or method. This compares with extensive trial and error approaches in which images are rendered on many different types of color-rendering devices and are assessed by eye. However, human beings are prone to subjectivity and the process can be time consuming and expensive.

In an example, a first type of printer may have been used to render posters, boards or other printed material in advance for use at a distant exhibition. If a replacement is required whilst at the exhibition, the same type of printer may not be available at the location of the exhibition. In this situation, it would be desirable to select, from amongst the locally available printers, a second type of printer that is most likely to closely replicate the original poster, board or other material. In another example, it may be desired to print an image on a new substrate which largely replicates the image printed on an old substrate (e.g. a textile material instead of paper). This may be achieved by selecting a different printer with different color rendering properties for printing onto the new substrate. In another example, it may be desired to select a replacement color rendering device which is able to replicate images rendered by an old color-rendering device which is no longer available.

Rendered color outputs produced in color-rendering devices depend on the color resources of the devices. Examples of color resources include available substrates (e.g. type of paper, textile or 3D printing build material), available colorants such as sets of colored inks and/or dyes or 3D printer printing fluids, available priming and/or finishing agents (e.g. varnishes and the like), printhead capabilities (e.g. output resolution or number of drops per nozzle), and printing speed. In display monitors, the color resources may include the light emitting technology used (e.g. Liquid Crystal Display (LCD), Organic Light-Emitting Diode (OLED) or Cathode Ray Tube (CRT)), screen resolution, interlacing method, and refresh rates. Color resources may also include elements of a color processing pipeline that are available to process digital image data representing a color image, for example color mapping components or tables for mapping image pixel color values from an input color space (e.g. RGB) to a color space appropriate for the color-rendering device (e.g. CYMK).

The rendering capabilities and characteristics of a color-rendering device may be described using one or more color reproduction parameters. Examples of color reproduction parameters may include a color gamut, size of a color gamut volume, lightness of black points, color consistency, Pantone coverage, printing fluid use, cost, image quality, grain, accuracy of characterization and color profiles. The color reproduction parameters of different color-rendering devices will be dependent on the color resources available to these devices.

A color gamut represents a range of renderable colors for a color-rendering device and may be defined as a volume in a multi-dimensional color space. The multi-dimensional color space may be device-dependent, e.g. have dimensions that are set by the physical properties and/or characteristics of a particular rendering device, or may be device-independent, e.g. be independent of any one rendering device. Red, Green, Blue (RGB) color spaces are typically device-dependent and have three dimensions or channels, each representing an intensity of one of the three colors; similarly, a Cyan, Magenta, Yellow and Black (CMYK) color space is a device-dependent color space that is dependent on a number of colorants used in a printing system (e.g. typically four dimensions). Examples of device-independent color spaces include those defined by the Commission Internationale de l'Eclairage (CIE) such as CIE-XYZ and CIE-L*a*b* color spaces.

A particular rendering device may have a particular color gamut in a particular color space, e.g. a monitor may have a three-dimensional volume in RGB color space representing all the colors that may be displayed by the monitor (i.e. data points that can be rendered) and a printer may have a three-dimensional volume in CMYK color space representing all the colors that may be displayed by the printer (i.e. data points that can be rendered). Gamut volume may be affected by color resources such as the inks used, the printing technique employed, and/or the substrate onto which the inks are deposited to render the image.

Color properties may also be described in other ways for some color-rendering devices. For example, a Neugebauer Primary area coverage (NPac) space may be deemed a print control space that controls a color output of an imaging device. It may also be considered, in certain cases, to correspond to a color space. An NPac vector in the NPac space represents a statistical distribution of one or more Neugebauer Primary (NP) vectors over an area of a halftone. In a simple binary (bi-level, i.e. two drop state: “drop” or “no drop”) printer, an NP is one of 2^{k} combinations of k inks within the printing system. For example, if a printing device uses CMY inks there can be eight NPs. These NPs relate to the following: C, M, Y, C+M, C+Y, M+Y, C+M+Y, and W (“white” or “blank” indicating an absence of ink). As may be seen, an NP may comprise an overprint of two available inks, such as a drop of cyan on a drop of magenta (for a bi-level printer) in a common addressable print area (e.g. a printable “pixel”). Other examples may also incorporate multi-level printers, e.g. where print heads are able to deposit N drop levels, for example via multiple print passes or print-bars; in this case an NP may include one of N^{k} combinations of k inks within the printing system. An NPac space provides a large number of metamers. Metamerism is the existence of a multitude of combinations of reflectance and emission properties that result in the same perceived color for a fixed illuminant and observer.

Lightness of black points is a measure of the darkness of black pixels rendered by a color-rendering device. Where the lightness of black points is too high, some other colors may be apparent which may be an artifact of the technology used. For example, a printer rendering black by mixing cyan, yellow, and magenta inks may not be able to reproduce the deepest black available to a printer with black ink. Similarly, an LCD display monitor may not be able to reproduce a deep black due to the backlighting used. Lightness of black points may be expressed using the minimum CIE L* value achievable for the color-rendering device.

Accuracy of characterization or color profiles are measures of the accuracy with which a color-rendering device can reproduce colors, for example accuracy of an ICC (International Color Consortium) color profile may be measured using round-trip accuracy or accuracy. A color profile or other color characterization method's accuracy may be evaluated by determining how it consistent is with itself. This method starts with a set of device color values (e.g. a uniform sampling of CMYK) and computing a first set of colorimetric values such CIE LAB values—International Commission on Illumination (CIE), where L is lightness from black (0) to white (100), A is from green (−) to red (+) and B is from blue (−) to yellow (+). The profile is then used to perform a forward (i.e. AtoB) transformation—from the device color space to a profile connection space. These CIE LAB values can then be transformed back to CMYK (via the profiles inverse BtoA resources) and then from there to a second set of colorimetric LAB values (via the profiles AtoB). Computing color difference statistics between first and second sets of LABs (e.g. using CIE ΔE2000) that quantifies the profile's round-trip accuracy or self-consistency. A color profiles accuracy may instead be obtained by following the same process as above, but instead of the last transformation being via the profile's AtoB resources, the device color data is output (e.g. printed) and color measured. Color differences are again computed between the first set and the second, in this case measured, set of colorimetry's.

When moving between color-rendering devices, defined colors may be mapped between color spaces. For example, a color image may be shown to a user of a design application via a computer monitor and may be stored as pixel values in an RGB color space. The user may then wish to print the image on a printing device. The printing device may have four colorants—CMYK—and thus represent colors in a CMYK color space. In this case, the color image in the RGB color space needs to be converted to a print image in CMYK color space. Hence, data points defined within a given range of three dimensions are to be converted into a given (and typically different) range in four dimensions. A color gamut for the computer monitor in RGB color space is to be mapped to a color gamut for the printing device in CMYK color space. However, the set of colors that are renderable on the computer monitor (e.g. that can be displayed) may differ from the set of colors that are renderable by the printing device (e.g. that can be printed).

Similarly, it may be desirable, where an image was previously printed on one type of printer, to try to replicate the printed image using a different type of printer and/or a different substrate. However, the set of colors that are renderable on the available printers may vary widely and/or may differ from those renderable by the original printer.

Certain examples described herein facilitate the reproduction of rendered color outputs based on desired color properties. For example, color outputs may be produced that replicate on a target color-rendering device the color outputs produced on a reference color-rendering device. Other examples may determine whether colors output by a reference device may be replicated on a target color-rendering device, e.g. whether this is possible or to what extent matching colors may be output.

Certain examples described herein provide a color matching system or method in which color matching parameters associated with different color-rendering devices are used in order to make an objective comparison. In an example, the color matching parameters may be used to confirm that a target color-rendering device can sufficiently replicate a color image renderable by a reference color-rendering device. In an example, the color matching parameters may be used to select from amongst a plurality of target color-rendering devices, the target color-rendering device most likely to replicate a color image renderable by a reference color-rendering device.

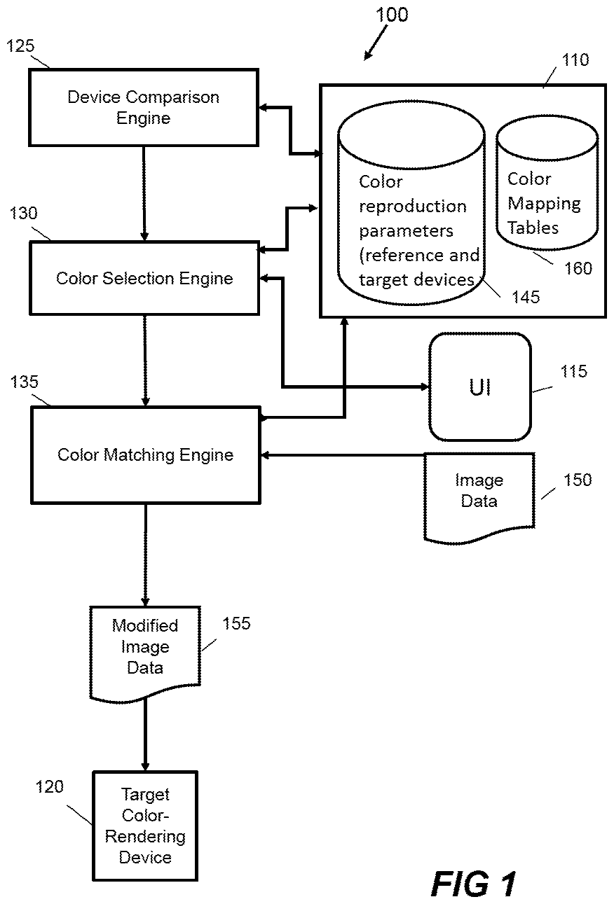

FIG. 1 shows a color matching system 100 according to an example. The color matching system 100 comprises a storage medium 110, a user interface 115, a device comparison engine 125, a color selection engine 130, and a color matching engine 135. The system 100 may receive image data 150 representing a color image to be rendered. The system 100 may be coupled to a target color-rendering device 120.

The device comparison engine 125, color selection engine 130 and color matching engine 135 may be implemented as a combination of hardware, such as control circuitry, and/or programming configured to perform the functionality described herein. One or more of these engines 125, 130, 135 may be implemented by a processor executing computer program code stored on the storage medium 110 or elsewhere.

The storage medium 110 stores a database 145 of color reproduction parameters for a number of color-rendering devices which may be used by the system as reference or target color-rendering devices. The color-reproduction parameters may include the color gamut for each device, their respective lightness of black points, and the accuracy of characterization of color profiles such as an International Color Consortium (ICC) color profile. Colors in the gamut may be defined by vectors having a dimensionality set by the gamut volume. Some device color spaces may be RGB-based or CYMK based, or a device independent color space, such as CIE-XYZ, or CIE-LAB. The storage medium 110 may also comprise color mapping tables 160 for use in mapping a color gamut in one color space to another.

For printer color-rendering devices, the output color space may be dependent on the inks available to the color-rendering device. The inks may also be considered as colorants, where colorants include other types of substances such as dyes, pigments, or paints. The color space may be an area coverage space, such as an NPac color space. An NPac color space recognizes that the colors producible by a set of inks may be dependent on the coverage areas of the inks.. An NPac may be seen as a possible output state for a print-resolution area. The set of NPs may depend on the configuration of a device in which they operate. This may include a dependence on the inks available, the printing levels (number of layers which can be applied, binary being the simplest), the drop volumes, drop numbers, etc. An example of a printing pipeline which may utilize an area coverage color space is a Halftone Area Neugebauer Separation (HANS) pipeline. A color mapping in this example may use a look-up table to map colorimetric values to vectors in an area coverage space.

The storage medium may be a non-transitory computer-readable storage medium for example, a hard drive, a CD-ROM disc, a USB-drive, a solid-state drive or any other form of magnetic storage device, optical storage device, or flash memory device, maintained locally or accessed remotely, capable of having thereon computer readable code suitable for the function described herein

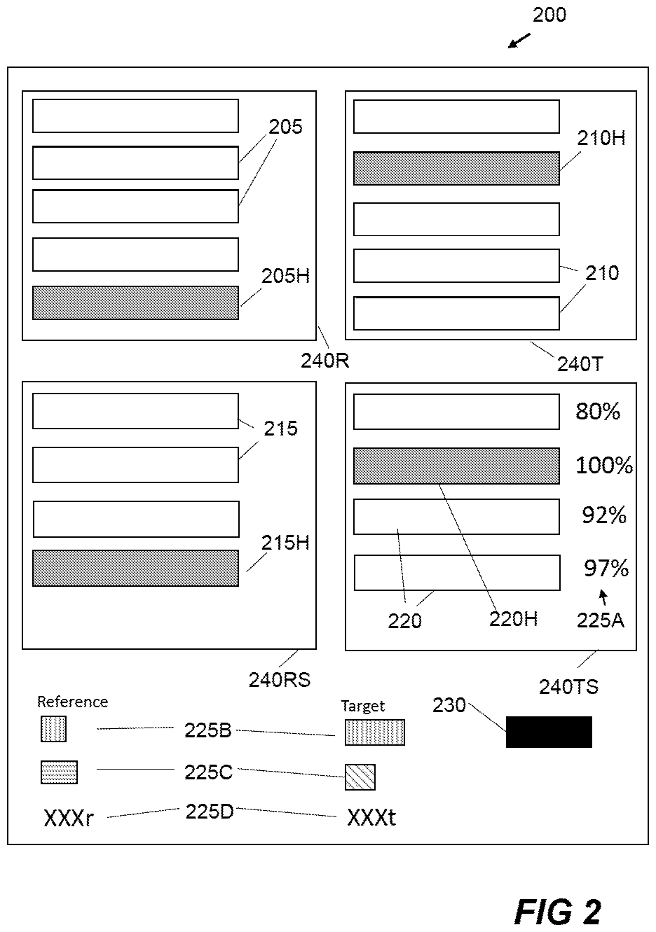

The user interface 115 may be a graphical user interface (GUI) which both displays information to a user and may receive user input such as a selection or confirmation. A GUI according to an example is shown in FIG. 2. The GUI 200 comprises four bounded areas each showing selectable options. The upper two bounded areas 240R and 240T correspond respectively to reference color-rendering devices 205 and target color-rendering devices 210. Each bounded area 240R and 240T may display a respective plurality of reference and target color-rendering devices. One of the reference color-rendering devices 205H and one of the target color-rendering devices 210H may be highlighted, e.g. when selected. The lower bounded areas 240RS and 240TS correspond respectively to selectable color resource options 215 and 220 such as substrates that may be selected for the highlighted reference and target devices. Again, configurations may be selected by a user and displayed with highlighting. One of the color resources 215H is shown as highlighted for the reference color-rendering device 205H that is highlighted in the upper left bounded area 240R. One of the color resources 220H is shown as highlighted for the target color-rendering device 210H that is highlighted in the upper right bounded area 240T. Other color resource options may also be added, for example, colorant sets and printing speeds.

The GUI 200 displays color matching parameters 225A-225D. The color matching parameters may be generated by the device comparison engine 125 and are based on a comparison of color reproduction parameters for the highlighted target color-rendering device 210H with color reproduction parameters for the highlighted reference color-rendering device 205H. In an example the color matching parameter may by a percentage similarity between a color reproduction parameter such as gamut volume of the reference and target devices as indicated by 225A. In another example, the color matching parameters may be a side-by-side display of one or more color reproduction parameters for the target and reference device as indicated by 225D. In an example, the color matching parameters may be graphical devices such as overlapping shapes representing respective color reproduction parameters, or bars or lines whose size, color or properties are dependent on the corresponding color matching parameters as indicated by 225B and 225C.

In one example, the color matching parameters 225A-D may be used by a user of the system 100 to select a target color-rendering device from amongst a plurality of target color-rendering devices which is most likely to replicate a rendering of a color image on the highlighted reference device 205H. As noted, this selection may also be dependent on the highlighting of respective selectable color resource options such as substrate. The color matching parameters 225A-D may be used by a user of the system 100 to confirm that a highlighted target color-rendering device is able to replicate a rendering of a color image on the highlighted reference device 205H. As noted, this selection may also be dependent on the highlighting of respective selectable color resource options such as substrate. In another example, the color matching parameters 225A-D may be evaluated without display on a graphical user interface, e.g. may be compared to one or more thresholds to make a selection without explicit user input. In certain cases, a determined selection made in this manner may be presented to a user for confirmation, e.g. via user interface 150.

In an example, a first color matching parameter 225A may be the extent to which one or more color gamut of the displayed substrate options 220 of the highlighted target device 210H overlap with the color gamut of the highlighted reference device 205H and substrate 215H. A figure of 95% may be considered acceptable, or 100% may be required. A second color matching parameter 225B may be the lightness of black points of the highlighted reference device 205H and substrate 215H (on the left) compared with the lightness of black points of the highlighted target device 210H and substrate 220H (on the right). This color matching parameter may be displayed graphically using bar icons having lengths corresponding to the respective color reproduction parameters. In this example, the lightness of the black points is better (e.g. darker) in the target color-rendering device 210H and 220H compared with the reference color-rendering device 205H and 215H. Other color rendering parameters may include accuracy of characterization of a standardized color profiles 225C and 225D.

Various methods may be used for selecting a target color-rendering device and substrate using one or a combination of the color matching parameters 225A-D. For example, a minimum percentage gamut overlap 225A of 95% together with the largest the positive difference between the reference and target devices in any one of the other color matching parameters 225B-D. In an example, a group of target color-rendering devices 210 and substrates 220 having a gamut overlap of 95% or greater is determined. Then from that group, where the color matching parameters 225B-D for each target device can be represented or converted to a percentage, the largest percentage is selected. If the largest color matching parameter (e.g. 225B) for one target device is 120% (i.e. the color reproduction parameter of the target device is 20% larger than the same color reproduction parameter of the reference device), but the largest parameter color reproduction parameter (e.g. 225C) for a second target device is 125%, then the second target device is selected. The selection process may be fully or partly automated with the user providing no or some input. One or more thresholds that are used in any comparison operation may be predefined and/or set dynamically based on a current configuration.

A selection button 230 may be used to select one of the target devices (and substrate). The system may then automatically configure color resources of the target device to replicate the color produced by the reference device (and highlighted substrate). This may take the form of mapping image data 150 intended for rendering a color image on the reference device into modified image data 155 intended for the selected target device so that the selected target color-rendering device 120 can replicate the color image on the target device. The modified image data 155 may comprise color-mapped image data.

The target color rendering device 120 may be a printer designed to use a set of inks to render an image onto a substrate or print medium using the set of inks. The target color-rendering device 120 may render the image onto the substrate by depositing inks from the set of inks onto the substrate. Throughout this description it is acknowledged that the terms “printer” and “printing” may also apply to three-dimensional printing systems, for example where colored agents are deposited onto a bed of print material such as a bed of powdered polymer particles. The inks used to render the image may be deposited in a controlled manner. The set of inks may comprise more than one color ink. An example of a set of inks used in an inkjet printer may include the colors Black, Cyan, Yellow, and Magenta. Different color-rendering devices may use different ink colors to produce the gamut available to the device 120. The gamut may be altered by altering the configuration of the color-rendering device 120. In an example, producing colors from the available inks may be done by halftoning, by mixing the inks directly, or by any other suitable printing technique.

A substrate may include paper, textiles, plastics, or any other medium onto which inks can be deposited to render an image. Different substrates may have different properties relevant to the deposit of printing fluid, such as adherence, absorbency, glossiness. A substrate may also refer to different types of screen for a display monitor, which may have different properties such as resolution, brightness, refresh rate, reflectance.

The image data 150 may take the form of a raster image file or a vector image file. In a raster image file, the image may be defined by a plurality of pixels, wherein each pixel comprises a series of digital values representing a color within a given color model. When an 8-bit RGB model is used, each pixel may comprise three 8-bit values representing quantities from 0 to 255. In a vector image file, the image may be defined by a series of geometric shapes, wherein these shapes have an associated color value. For example, a square may be defined as extending from pixel co-ordinate A to pixel co-ordinate B and have an associated 8-bit RGB value. The term image is not limited to literal digital images and may data that includes text and typography definitions, as well as other visual information to be printed.

Once a target color-rendering device 120 is selected or confirmed, the color matching engine may select a substrate for the device 120, a set of inks or other colorants, a printing speed, and other settings. In one case, the selection may be performed to optimize (e.g. maximize) a set of one or more color matching parameters, e.g. to enable a rendering of image data that “best” matches the reference color-rendering device. The color matching engine may transform the image data 150 into modified image data 155 as part of configuring the color resources of the target device for replicating the rendering of the image data by a reference device. Various color mapping resources may be utilized, including, for example, color (e.g. ICC) device links for the reference and target color-rendering devices, a color (e.g. ICC) output profile for the target color-rendering device, mapping tables 160 that map pixels in the image data from the color space of the reference color-rendering device to corresponding pixels in the modified image data in the color space of the target color-rendering device.

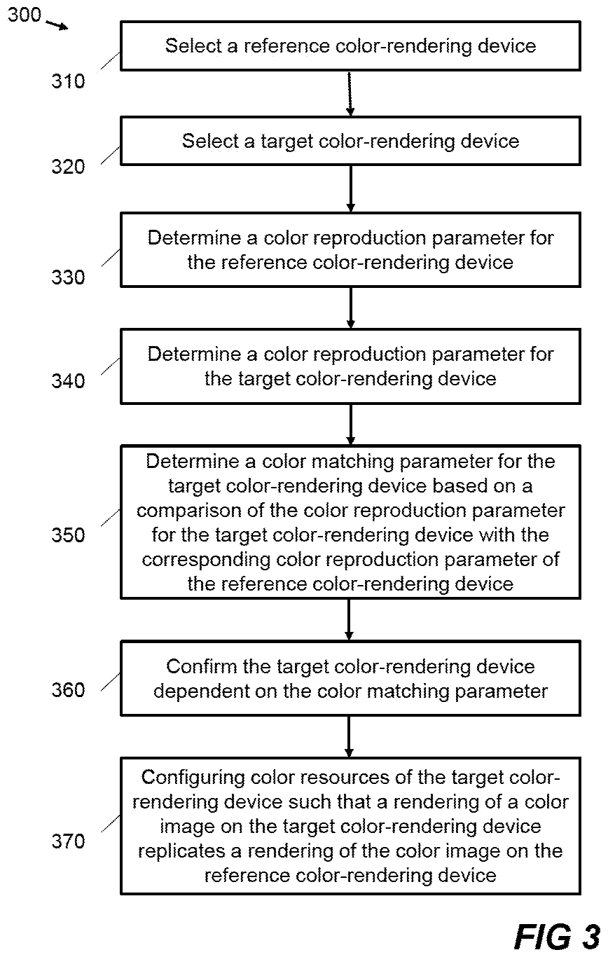

FIG. 3 illustrates a flow diagram of an example method 300 of color matching reference and target color-rendering devices. At block 310, the method comprises selecting a reference color-rendering device. This may be implemented using the GUI described in FIG. 2, in which a user may be presented with several reference color-rendering device options 205 and is able to select one of these 205H by highlighting or another user selection process. In another example, the reference device may be automatically selected, for example by determining a color-rendering device previously used to print a particular image, or receiving a reference color-rendering device identifier with image data.

Selecting a reference color-rendering device may also include selecting color resources or configuration aspects of the device, such as the substrate used, the set of colorants used, the speed of printing, the ink limit, total coverage area, number of passes. The block 310 may be implemented using a color selection engine 130, although other implementations are possible.

At block 320, the method comprises selecting a target color-rendering device. This may be implemented using the GUI described in FIG. 2, in which a user may be presented with several target color-rendering device options 210 and is able to select one of these 210H by highlighting or another user selection process. In another example, the target device may be automatically selected, for example by determining the only available color-rendering device or one (e.g. the first) of a number of color-rendering devices identified in received image data.

Selecting a target color-rendering device may also include selecting color resources or configuration aspects of the device, such as the substrate used, the set of colorants used, and the speed of printing. The block 320 may be implemented using a color selection engine 125, although other implementations are possible.

At block 330, the method comprises determining a color reproduction parameter for the selected reference color-rendering device 205H. Color reproduction parameters of the reference device may include color gamut, gamut volume, lightness of black points and accuracy of characterization of color profiles such as the round-trip accuracy of ICC profiles. The color reproduction parameters of the reference color-rendering device may be stored in a database 145 and may be retrieved by the device comparison engine 125, although other implementations are possible.

At block 340, the method comprises determining a color reproduction parameter for the selected target color-rendering device 210H. Color reproduction parameters of the target device may include color gamut, lightness of black points and accuracy of characterization of color profiles such as the round-trip accuracy of ICC profiles. The color reproduction parameters of the target color-rendering device may be stored in a database 145 and may be retrieved by a device comparison engine 125, although other implementations are possible.

At block 350, the method comprises determining a color matching parameter for the target color-rendering device based on a comparison of the color reproduction parameter for the target color-rendering device with the corresponding color reproduction device of the reference color-rendering device. For example, the color gamut of each device may be compared, and a percentage overlap may be calculated. A value of 100% would indicate that the two gamuts are the same, whereas a lower value may indicate that the gamut of the target device is smaller or larger than the gamut of the reference device and/or that the gamuts partially overlap but that each gamut may cover some color values not covered by the other gamut. Block 350 may be implemented by a device comparison engine 125, although other implementations are possible. The color matching parameter may be displayed to a user for example using the GUI of FIG. 2 or a different user interface or may be stored for use by an automated algorithm.

Additional or alternative color matching parameters may be determined corresponding to different pairs of color reproduction parameters. For example, the following color matching parameters may be determined: difference in color gamut volume; difference in lightness of black points; difference in accuracy of characterization of color profiles. These differences may be expressed as a percentage difference, display of the respective values in predetermined units, a visual indication of different magnitudes as shown by the bars 225B-C in FIG. 2.

At block 360, the method comprises confirming the target color-rendering device dependent on the color matching parameter(s). This may be implemented by an indicator confirming that the color matching parameter(s) is within a desired range, for example a “MATCH” icon (not shown) may be displayed when a selected reference color-rendering device and a selected target color-rendering device having color matching parameters within predetermined limits or with predetermined relationships. The icon may then be selected by a user to appropriately configure the target color-rendering device. In this way the block 360 may also be used to determine whether or not a target color-rendering device is likely to be successful in replicating color images rendered by a reference color-rendering device. This may assist in determining a device upgrade path or new substrate sourcing. It may also assist in determining the likelihood that a printer can sufficiently replicate what is seen on a display monitor.

In another example, the block 360 may determine whether predetermined limits or relationships of the color matching parameters are achieved and, if so, automatically configure the target device. In yet another example, the color matching parameters may be displayed visually on a GUI for example as illustrated in FIG. 2. A user may then manually determine whether that the color matching parameters are sufficient and confirm configuration of the target printer, for example by selecting a confirmation button 230. The block 260 may be implemented by a color selection engine 135 although other implementations are possible.

As noted above the selected devices may correspond to devices with specific color resource configurations such as substrates and available colorants. Therefore, the confirmation may relate to a target device with one type of substrate being able to sufficiently replicate color rendering by a different reference device using the same or a different type of substrate. For example, both devices may be printers but one using paper and the other using textile substrates.

The block 260 may also be used to select from amongst several reference color-rendering devices and/or several target color-rendering devices using the respective color matching parameter(s). For example, a gamut matching value of 100% for one of the selected target devices may be selected or confirmed when the gamut matching values of other target devices range between 80-90%. A combination of color matching parameters may be used to confirm a target device or to select from amongst several target devices. In another example, a first color matching parameter matching is above a threshold and a second color matching parameter (e.g. lightness of black points, accuracy of characterization of color profile) with the largest positive difference is confirmed or selected. For example, the target device having the best (darkest) lightness of black points parameter may be confirmed or selected, when the gamut matching value is better than 95%. In another example, a target device may not be confirmed if a color matching parameter is negative or indicates that a particular color reproduction parameter (e.g. round-trip accuracy of characterization of an ICC profile) is lower that than of the reference device. In certain cases, a multi-variable optimization may be performed to optimize a plurality of color matching parameters, e.g. to find extrema for each parameter that represents a “best” match. In certain case, a plurality of Pareto optimal configurations may be displayed for selection by a user and/or additional optimization. For example, a number of configurations of a target color-rendering may be possible and a user may then additionally select an option to further optimize based on ink use (e.g. to minimize colorant usage).

At block 370, the method comprises configuring color resources of the target color-rendering device such that a rendering of a color image on the target color-rendering device replicates a rendering of the color image on the reference color-rendering device. The color resources may include instructions regarding the substrate to be used, the colorants to be used and the speed of printing. The color resources may include transforming image data corresponding to the color image into modified image data for rendering on the target color-rendering device. The image data may be defined in a color space associated with the reference device or a device independent color space and may be mapped to a color space associated with the target device. This may be implemented in many ways including for example using: color (e.g. ICC) device links for the reference and target color-rendering devices; a color (e.g. ICC) output profile for the target color-rendering device; mapping tables 160 that map pixels in the image data from an input color space (e.g. of the reference color-rendering device or a device independent color space) to corresponding pixels in the modified image data in a color space of the target color-rendering device. The color reproduction parameters of the target color-rendering device may be stored in a database 145 and may be retrieved by a color matching engine 135, although other implementations are possible.

The method 300 may be combined with color verification where once a target and reference device pairing or matching is confirmed and the target device configured, the rendered color images from each device are measured in order to determine the accuracy of the match. This may help improve subsequent confirmation or selections, for example by weighting color matching parameters, color reproduction parameters or color resources associated with each color-rendering device. In another example, a parameter may be defined which is derived from collected color verification data and may be used as an additional input for confirming a target color-rendering device or for configuring the color resources of the target color-rendering device.

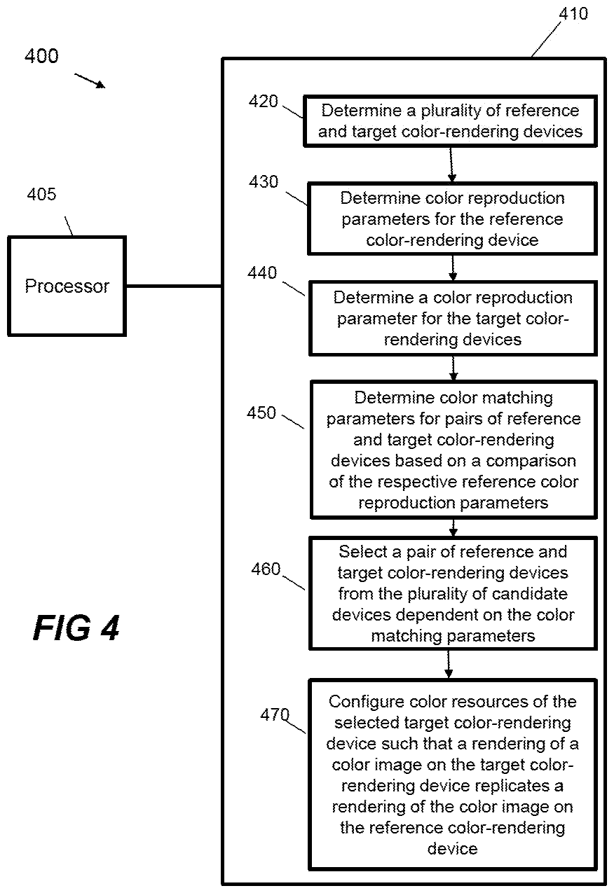

FIG. 4 shows a schematic diagram of an example non-transitory computer-readable storage medium 410 storing instructions that, when executed by a processor 405, cause the processor 405 to perform the operations described below. A first set of instructions 420 may cause the processor 405 to determine a plurality of reference and target color-rendering devices and may include configuration information such as substrate to be used. The devices may be determined from a set of devices in a database and/or by user selection, for example using a GUI. In one example a reference color-rendering device may be determined by an identifier forwarded with image data for rendering a color image using the identified color-rendering device.

A second set of instructions 430 may cause the processor 405 to determine color reproduction parameters for the reference color-rendering devices. A third set of instructions 440 may cause the processor 405 to determine color reproduction parameters for the reference color-rendering devices. These color reproduction parameters may be retrieved from a database.

A fourth set of instructions 450 may cause the processor 405 to determine color matching parameters for pairs of reference and target color-rendering devices based on a comparison of the respective reference color parameters. A method for determining color matching parameters has been described with respect to FIG. 3. The color matching parameters may be displayed to a user, for example using the GUI of FIG. 2.

A fifth set of instructions 460 may cause the processor 405 to select a pair of reference and target color-rendering devices from the plurality of candidate devices dependent on the color matching parameters. This may be implemented by user-guided selection as described with respect to the GUI of FIG. 2. The selection may be made on the basis of automatic selection algorithms, for example the “best” match in one color matching parameter or a predefined relationship amongst a number of color matching parameters such as the reference-target pair having a first color matching parameter within a threshold AND a second color matching parameter corresponding to the largest positive difference between the associated color rendering parameter of the reference and target device AND a third color matching device which is not negative (e.g. the associated color rendering parameter of the reference device is not less than the same color rendering parameter of the target device).

A sixth set of instructions 460 may cause the processor 405 to configure color resources of the selected target color-rendering device such that a rendering of a color image on the target color-rendering device substantially replicates or sufficiently approximates a rendering of the color image on the reference color rendering device. The accuracy of the replication may be measured using test color image renderings such that the color reproduction parameters associated with the reference and target devices may be modified to improve the replication accuracy. Other variables may also be modified by the measurements in order to improve replication accuracy, for example the determination of the color matching parameters and/or the configuring of the color resources of the selected target color-rendering device.

Certain examples described herein allow for a user of a guided color matching system to select or confirm a target color-rendering device to replicate the rendering of a color image by a reference color-rendering device. Color reproduction parameters of the respective devices may be used together with color matching parameters to provide an objective mechanism for selecting and/or to provide an indication of the likelihood of a good color match between selected pairs of reference and target color-rendering devices. This may allow a user to more confidently assign print jobs to available printers, to assist with device upgrade pathways, and to assess how best to change substrate and other color resources such as ink supplier.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
selecting a reference color-rendering device;
selecting a target color-rendering device;
determining a color reproduction parameter for the reference color-rendering device and a color reproduction parameter for the target color-rendering device;
determining a color matching parameter for the target color-rendering device based on a comparison of the color reproduction parameter for the target color-rendering device with the corresponding color reproduction parameter of the reference color-rendering device;
confirming the target color-rendering device dependent on the color matching parameter; and
configuring color resources of the target color-rendering device such that a rendering of a color image on the target color-rendering device replicates a rendering of the color image on the reference color-rendering device.

2. The method of claim 1, comprising selecting from amongst a plurality of target color-rendering devices by determining respective color matching parameters.

3. The method of claim 1, wherein confirming the target color-rendering device comprises displaying the color matching parameter and receiving a user selection.

4. The method of claim 1, wherein selecting the reference and/or target color rendering devices comprises selecting respective configuration parameters comprising one or more of: substrate type; available colorants; and printing speed.

5. The method of claim 1, wherein the color reproduction parameters of the reference and/or target color-rendering device include one or more of: color gamut; lightness of black points; and accuracy of characterization of color profiles.

6. The method of claim 1, wherein the color matching parameter includes one or more of: percentage matching color gamut; color gamut volume difference; difference in lightness of respective black points; and difference in accuracy of color profiles.

7. The method of claim 1, wherein configuring color resources of the target color-rendering device comprises transforming image data into modified image data for rendering on the target color-rendering device using one or more of the following: color device links for the reference and target color-rendering devices; a color output profile for the target color-rendering device; and a mapping resource that maps pixels in the image data from a color space of the reference color-rendering device to corresponding pixels in the modified image data in a color space of the target color-rendering device.

8. The method of claim 1, wherein confirming one of a number of target color-rendering devices comprises confirming that a first color matching parameter of the confirmed target color-rendering device is within a threshold and that a second color matching parameter of the confirmed target color-rendering device has a largest positive difference amongst the number of reference color-rendering devices.

9. A system comprising:
a database of color reproduction parameters for a plurality of color-rendering devices;
a device comparison engine to retrieve color reproduction parameters for first and second color-rendering devices from the database and to determine a color matching parameter for the second color-rendering device based on a comparison of the retrieved color reproduction parameters;
a color selection engine to receive a selection of a reference color-rendering device from the plurality of color-rendering devices and to instruct the device comparison engine to determine color matching parameters with the first color-rendering device set as the reference color-rendering device,
wherein the color selection engine uses the color matching parameters to select a target color-rendering device from the plurality of color-rendering devices; and
a color matching engine to configure color resources of the target color-rendering device selected by the color selection engine such that a rendering of a color image on the target color-rendering device replicates a rendering of the color image on the reference color-rendering device.

10. The system of claim 9, wherein the database comprises color reproduction parameters corresponding to different configuration parameters for the plurality of color-rendering devices having a plurality, and wherein the color selection engine receives a selection of respective configuration parameters with the selection of the reference and target color-rendering devices.

11. The system of claim 10, wherein the configuration parameters comprise one or more of: substrate type; available colorants; and printing speed.

12. The system of claim 9, wherein the color selection engine is to control a user interface to display the color matching parameters and to receive a user selection.

13. The system of claim 9, wherein the reference color-rending device is a display monitor and the target color-rendering device is a printer.

14. The system of claim 9, wherein the reference and target color-rendering devices are both printers.

15. A non-transitory computer-readable storage medium storing instructions that, when executed by a processor, cause the processor to:
receive an indication of a reference color-rendering device;
determine a color reproduction parameter for the reference color-rendering device;
determine a set of color reproduction parameters for a plurality of candidate color-rendering devices;
determine color matching parameters for respective pairs of the reference color-rendering device and a selected one of the plurality of candidate color-rendering devices based on a comparison of respective color reproduction parameters;
select a target color-rendering device from the plurality of candidate color-rendering devices dependent on the color matching parameters; and
configure color resources of the target color-rendering device such that a rendering of a color image on the target color-rendering device replicates a rendering of the color image on the reference color-rendering device.
